(19) United States
(12) Patent Application Publication
(10) Pub. No.: US 2008/0183315 A1
(43) Pub. Date: Jul. 31, 2008

(54) VIDEO SIGNAL CONTROL CIRCUIT

(75) Inventors: KUO-SHENG CHAO, Tu-Cheng (TW); MING-CHIH HSIEH, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/778,090

(22) Filed: Jul. 16, 2007

(30) Foreign Application Priority Data
Jan. 29, 2007 (TW) 96103138

(51) Int. Cl. G06F 17/00

(52) U.S. Cl. 700/90

(57) ABSTRACT

An exemplary video signal control circuit includes a central processing unit, a signal bus, an address bus, a data bus, a latch module, and a display module. The central processing unit is connected to a latch-enable terminal of the latch module via the signal bus and connected to an input-enable terminal of the latch module via the address bus for controlling the latch module. The central processing unit transmits video signals to the latch module via the data bus and then to the display module if the latch module is latch-enabled and input-enabled. The video signal control circuit transmits the video signal to the display module via the data bus instead of general port I/O pins, and thus the quantity of display units is not restricted by the quantity of the general port I/O pins.

### BACKGROUND OF THE INVENTION

1. Field of the Invention

The present invention relates to control circuits, and particularly to a video signal control circuit.

2. Description of Related Art

The early central processing units (CPUs), for example the Intel 8086, advanced RISC machines (ARM), and microprocessor without interlocked piped stages (MIPS) chipsets, use general purpose input output (GPIO) pin to control display units such as a liquid crystal display (LCD) or a light emitting diode (LED) display for displaying data generated by the CPUs. Each one of the displays will occupy at least one GPIO pin of the CPU to receive data, for example an LED display, which includes seven LEDs, will occupy nine GPIO pins of a CPU to display the numbers 0 to 9.

Therefore, the quantity of the LED displays connected to the CPU is limited by the quantity of the GPIO pins of the CPU.

What is needed, therefore, is a video signal control circuit which can solve above problem.

### SUMMARY OF THE INVENTION

An exemplary video signal control circuit includes: a central processing unit; a latch module having a latch-enable terminal connected to the central processing unit via a signal bus, and an input-enable terminal connected to the central processing unit via an address bus, the latch module further connected to the central processing unit via a data bus for receiving data generated by the central processing unit; and a display module connected to the latch module to receive and display the data when the latch module is latch-enabled and input-enabled.

Other advantages and novel features will become more apparent from the following detailed description when taken in conjunction with the accompanying drawings, in which:

### BRIEF DESCRIPTION OF THE DRAWINGS

FIG. 1 is a block diagram of one embodiment of a video signal control circuit in accordance with the present invention; and

FIG. 2 is a circuit diagram of FIG. 1.

### DETAILED DESCRIPTION OF THE INVENTION

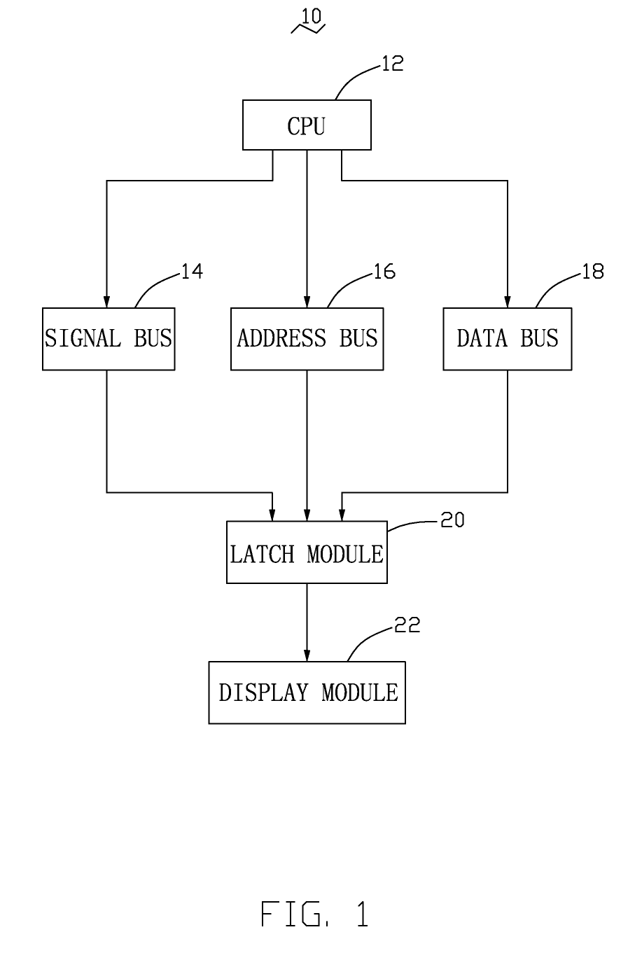

Referring to FIG. 1, a video signal control circuit 10 in accordance with an embodiment of the present invention includes: a central processing unit (CPU) 12; a latch module 20 having a latch-enable terminal LE connected to the CPU 12 via a signal bus 14, and an input-enable IE terminal connected to the CPU 12 via an address bus 16, the latch module 20 is further connected to the CPU 12 via a data bus 18 for receiving data generated by the CPU 12; and a display module 22 connected to the latch module 20 to receive and display the data when the latch module 20 is latch-enabled and input-enabled.

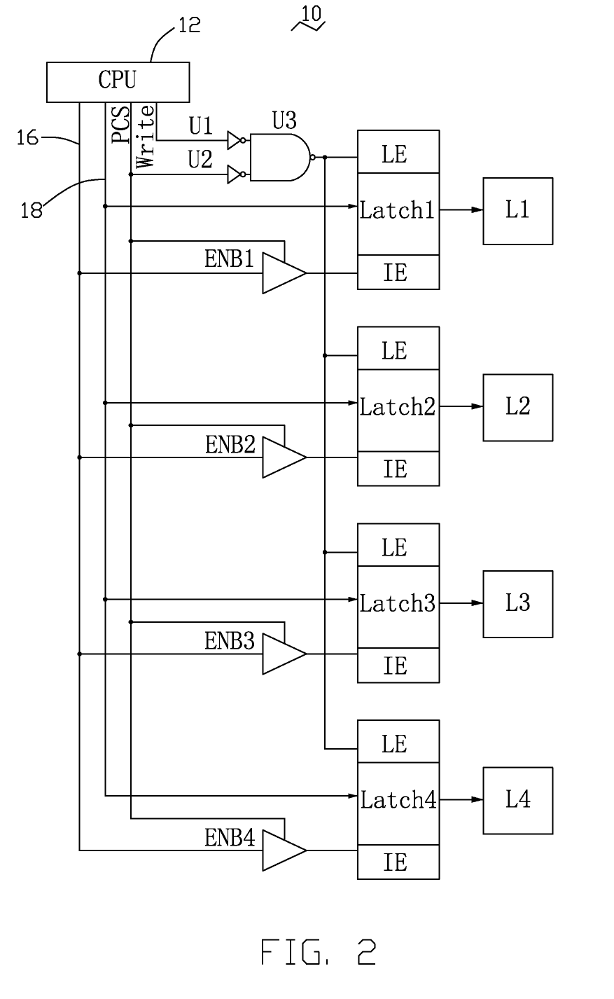

Referring to FIG. 2, the latch module 20 includes four latches Latch1˜Latch4. The display module 22 includes four LED displays L1˜L4, which are connected to the corresponding latches Latch1˜Latch4 respectively. The CPU 12 is connected to the latches Latch1˜latch4 via the data bus 18 for transmitting the data.

The address bus 16 is connected to the input-enable terminals IE of the latches Latch1˜Latch4 via corresponding switches ENB1˜ENB4 respectively. The signal bus 14 further includes a write signal wire Write and a selection signal wire PCS connected to two input terminals of a NAND gate U3 via corresponding not gates U1˜U2 respectively. The output terminal of the NAND gate U3 is connected to the latch-enable terminals LE of the latches Latch1˜Latch4. The selection signal wire PCS is further connected to the switches ENB1˜ENB4 for transmitting a control signal to control whether the switches ENB1˜ENB4 are turned on.

In this exemplary embodiment, the address bus 16 includes a four bit address A1˜A4 corresponding to the latches Latch1˜Latch4. That is, the addresses 1110, 1101, 1011, and 0111 make the latches Latch1˜Latch4 input-enabled respectively.

When the write signal wire Write and the selection signal wire PCS transmit a low level voltage signal, the latches Latch1˜Latch4 are latch-enabled and the switches ENB1˜ENB4 are turned on. Then one of the addresses A1˜A4 is transmitted to the input-enable terminals IE of the latches Latch1˜Latch4 for selecting a latch to be input-enabled.

Therefore, the latch, which is input-enabled, will transmit the data generated by the CPU 12 to the corresponding LED display to display the data.

Additionally, the latches Latch1˜Latch4 also can be selected at a same time, for example an address 1010 can make the latches Latch1 and Latch3 input-enabled. Further, the latches are not limited to four, other quantities may be used provided they are no more in number than the number of address bits in the address bus.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A video signal control circuit comprising:
a central processing unit;
a latch module having N latches each comprising a latch-enable terminal connected to the central processing unit via a signal bus, and an input-enable terminal connected to the central processing unit via an address bus, each of the latches further connected to the central processing unit via a data bus for receiving data generated by the central processing unit; and
a display module comprising N displays each connected to one corresponding latch of the latch module to receive and display the data when the corresponding latch is latch-enabled and input-enabled,
wherein N is a positive integer.

2. The video signal control circuit as claimed in claim 1, wherein the displays are LED displays.

3. The video signal control circuit as claimed in claim 1, wherein the signal bus includes a write signal wire and a selection signal wire connected to two input terminals of a NAND gate via a corresponding not gate respectively, an output terminal of the NAND gate is connected to the latch-enable terminals of the latches.

4. The video signal control circuit as claimed in claim 3, wherein the selection signal wire is connected to N switches for selectively turning on the switches; each of the N switches is connected between the input-enable terminal of one corresponding latch and the data bus.

5. The video signal control circuit as claimed in claim 4, wherein N=4.

6. A video signal control circuit comprising:
a central processing unit (CPU);
a latch module comprising N latches each having a latch-enable terminal, and an input-enable terminal;
a data bus connecting the CPU with the latches;
an address bus connected to the input-enable terminal of each of the latches via a switch;
a signal bus connected to the latch-enable terminals of the latches and connected to the switches for selectively turning on the switches such that the data bus is capable of transmitting data to one or more of the latches which is or are latch-enabled and input-enabled; and
a display module comprising N displays each connected to one corresponding latch of the latch module to receive and display the data;
wherein N is a positive integer.
